(19) United States
(12) Patent Application Publication
(10) Pub. No.: US 2024/0120527 A1
(43) Pub. Date: Apr. 11, 2024

(54) SOLID-STATE ELECTROLYTE FOR IMPROVED BATTERY PERFORMANCE

(71) Applicant: The Florida International University Board of Trustees, Miami, FL (US)

(72) Inventors: Bilal M. El-Zahab, Miami, FL (US); Osama Awadallah, Miami, FL (US); Dambar Hamal, Miami, FL (US)

(21) Appl. No.: 18/262,491

(22) PCT Filed: Jul. 12, 2021
(86) PCT No.: PCT/US2021/041248

§ 371 Date: Jul. 21, 2023

Related U.S. Application Data
(60) Provisional application No. 63/140,570, filed on Jan. 22, 2021.

(51) Int. Cl. H01M 10/0562; C01B 25/45; C01G 55/00; H01M 4/38; H01M 4/58; H01M 10/0525; H01M 50/451

(52) U.S. Cl. CPC H01M 10/0562; C01B 25/45; C01G 55/002; H01M 4/382; H01M 4/5825; H01M 10/0525; H01M 50/451; H01M 2004/028; H01M 2300/0068

(57) ABSTRACT

Solid-state electrolytes for use in lithium-ion (Li-ion) batteries, as well as methods of synthesizing the same, methods of preparing the same into a film, and methods of using the same in a Li-ion battery, are provided. Solid-state electrolyte pellets can be prepared in a solution, and a film using the synthesized pellet can be formed and used in a Li-ion battery.

### CROSS-REFERENCE TO RELATED APPLICATION

This application claims the benefit of U.S. Provisional Application Ser. No. 63/140,570, filed Jan. 22, 2021, the disclosure of which is hereby incorporated by reference in its entirety, including all figures, tables and drawings.

### BACKGROUND

Lithium-ion-conductive solid-state electrolyte research was primarily driven by the need to develop a safer alternative to flammable liquid electrolytes in lithium-ion batteries. Research into solid-state electrolytes has shown various benefits of these materials including improved energy density, rate capability, and cyclability of the battery. Solid-state electrolytes belong to two main categories—organic and inorganic. Organic solid-state electrolytes mainly include lithium-ion-conductive polymers, while inorganic solid-state electrolytes mainly include lithium-ion-conductive ceramics and glasses.

The use of solid-state polymer electrolytes in lithium-based batteries began in the 1980s after the discovery of lithium-ion conduction in a polyethylene oxide (PEO)-based system (Fenton et al., Complexes of alkali metal ions with poly(ethylene oxide), Polymer 14, 589, 1973). Since then various lithium-ion conductive polymers (e.g., poly(acrylonitrile), poly(methyl methacrylate), and poly(vinylidene fluoride)) have been investigated for use in all solid-state polymer lithium-ion batteries.

The use of inorganic solid-state electrolytes research began in the 1990s with the development of lithium phosphorus oxynitride (LiPON) at Oak Ridge National Laboratory (Dudney et al., Sputtering of lithium compounds for preparation of electrolyte thin films, Solid-state Ionics 53-56, 655-661, 1992; Bates et al., Electrical properties of amorphous lithium electrolyte thin films, Solid-state Ionics 53-56, 647-654, 1992). Since then, other inorganic lithium-ion conductive materials have been used, such as perovskites, sodium supertonic conductor (NASICON), garnet, and sulfide-type materials (Kennedy et al., Preparation and conductivity measurements of SiS2—Li2S glasses doped with LiBr and LiCl, Solid-state Ionics, 18-19, 368-371, 1986; Kennedy et al., A highly conductive Li+-glass system: (1-x)(0.4SiS2-0.6Li2S)-xLil, J. Electrochem. Soc., 133, 2437-2438, 1986). Since the 2000s, solid-state electrolytes have been used in emerging lithium batteries such as lithium-air batteries, lithium-sulfur batteries, and lithium-bromine batteries.

### BRIEF SUMMARY

Embodiments of the subject invention provide novel and advantageous solid-state electrolytes (e.g., lithium palladium sulfide) for use in lithium-ion (Li-ion) batteries, as well as methods of synthesizing the same, methods of preparing the same into a film, and methods of using the same in a Li-ion battery. The solid-state electrolytes of embodiments provide improved stability of the battery over the cycling life (e.g., over 650 cycles), as well as the ability for the battery to resist lithium anode corrosion and/or protection for the battery from shorting by blocking the formation and electrolyte penetration (crossover) of dendrites. Solid-state electrolyte pellets can be prepared in a solution, and a film using the synthesized pellet can be formed and used in a Li-ion battery. The batteries comprising the solid-state electrolyte exhibit higher stability and lower capacity fade over the life of many cycles (e.g., 650 cycles).

In an embodiment, a battery can comprise: an anode; a cathode; and a solid-state electrolyte disposed between the anode and the cathode, at least one of the anode and the cathode comprising lithium, and the solid-state electrolyte comprising lithium palladium sulfide (LPS), lithium platinum sulfide, lithium rhodium sulfide, lithium iridium sulfide, lithium osmium sulfide, lithium ruthenium sulfide, lithium silver sulfide, or lithium cobalt sulfide. The anode and the cathode can both comprise lithium. The cathode can comprise, for example, lithium iron phosphate (LFP), nickel cobalt aluminum (NCA), or nickel manganese cobalt (NMC). The anode can be, for example, a lithium metal anode. The solid-state electrolyte can have an ionic conductivity of, for example, greater than or equal to 0.10 milliSiemens per centimeter (mS/cm). The battery can further comprise a separator (e.g., a polypropylene separator) disposed between the anode and the cathode. The solid-state electrolyte can comprise a first film coated on the anode; the solid-state electrolyte can comprise a second film coated on the cathode; and/or the solid-state electrolyte can comprise a third film coated on the separator. The battery can be an Li-ion battery, a lithium-air (Li-air) battery, or a lithium-sulfur (Li-sulfur) battery. The solid-state electrolyte can be disposed in the form of a film with a thickness of, for example, at least 20 nanometers (nm), at least 20 micrometers (μm), at least 100 μm, at most 100 μm, about 20 μm, or about 100 μm. The battery can have higher than 50% of theoretical capacity after at least 450 1C cycles. The battery can have higher than 80% of theoretical capacity after at least 200 1C cycles. The battery can have higher than 80% of theoretical capacity after at least 300 1C cycles.

In another embodiment, a method of fabricating a solid-state electrolyte can comprise: preparing a powder; and preparing a film of the solid-state electrolyte from the powder, the solid-state electrolyte comprising LPS, lithium platinum sulfide, lithium rhodium sulfide, lithium iridium sulfide, lithium osmium sulfide, lithium ruthenium sulfide, lithium silver sulfide, or lithium cobalt sulfide. The preparing of the powder can comprise: dissolving a first salt, a lithium salt, and a sulfur source in a first solvent to form a first solution; heating the first solution at a first temperature for a first amount of time to precipitate the sulfide compound comprising lithium and a first component from the first salt; and drying the sulfide compound at a second temperature for a second amount of time to give the powder; the first salt being a palladium salt, a platinum salt, a rhodium salt, an iridium salt, an osmium salt, a ruthenium salt, a silver salt, or a cobalt salt; and the first component being palladium, platinum, rhodium, iridium, osmium, ruthenium, silver, or cobalt. The preparing of the powder can alternatively comprise: dissolving a second salt, a lithium salt, and a sulfur source in a second solvent to form a second solution; soaking the second solution in a disc and placing the soaked disc between a positive electrode and a negative electrode to form a first cell; heating the first cell at a third temperature for a third amount of time while performing a potentiostatic operation on the first cell to precipitate on the negative electrode the sulfide compound comprising lithium and a second component from the second salt; and recovering the sulfide compound from the negative electrode to give the powder; the second salt being a palladium salt, a platinum salt, a rhodium salt, an iridium salt, an osmium salt, a ruthenium salt, a silver salt, or a cobalt salt; and the second component being palladium, platinum, rhodium, iridium, osmium, ruthenium, silver, or cobalt. The preparing of the powder can alternatively comprise: mixing, using a ball mill, lithium sulfide (Li2S) and a second sulfide comprising a transition metal to form a ball mill mixed compound; milling the ball mill mixed compound at a first speed for a fourth amount of time to form a sulfide compound comprising lithium and the transition metal; and drying the sulfide compound at a fourth temperature for a fifth amount of time to give the powder; the transition metal being palladium, platinum, rhodium, iridium, osmium, ruthenium, silver, or cobalt. The method can further comprise, for example, any of the features discussed herein in the Examples.

In another embodiment, a method of fabricating a battery can comprise: fabricating a solid-state electrolyte as disclosed herein; and depositing the solid-state electrolyte by coating it on the anode of the battery, coating it on the cathode of the battery, and/or coating it on a separator of the battery.

### BRIEF DESCRIPTION OF DRAWINGS

FIG. 1 is an image of a lithium palladium sulfide (LPS) pellet.

FIG. 2 is an image of a side view of an LPS composite gel polymer electrolyte.

FIG. 3 is scanning electron microscope (SEM) image of an LPS composite gel polymer electrolyte deposited on the surface of a polypropylene separator. The film shows an average thickness of 20 micrometers (μm). The scale bar is 100 μm.

FIG. 4 is a Nyquist plot of an LPS pellet showing the bulk conductivity obtained from the diameter of the semi-circle.

FIG. 5 is a plot of discharge capacity (in milliamp hours per gram (mAh/g)) versus cycle number, showing cycling performance of LPS electrolyte, a liquid electrolyte in Celgard, and LISICON (lithium super ionic conductor, which refers to an electrolyte with the chemical formula Li₂₊₂ₓZn₁₋ₓGeO₄) commercial solid-state electrolyte in lithium versus lithium iron phosphate batteries. The (red) curve with the highest discharge capacity value at 436 cycles is for the LPS; the (blue) curve with the second-highest discharge capacity value at around 200 cycles is for Celgard; and the (green) curve with the lowest discharge capacity value at around 200 cycles is for LISICON.

FIG. 6 is a scanning electron microscope (SEM) image of LPS powders resulting from an aqueous sulfurization method, according to an embodiment of the subject invention. The scale bar is 100 nanometers (nm).

FIG. 7 is an SEM image of LPS powders resulting from a mechanical ball milling method, according to an embodiment of the subject invention. The scale bar is 1 μm.

FIG. 8 is a plot of heat flow (in Watts per gram (W/g)) and weight percentage (%) versus temperature (in ° C.) showing a differential scanning calorimetry thermogram of heat flow for an LPS compound.

FIG. 9A shows an X-ray diffraction (XRD) pattern of an as-synthesized LPS compound.

FIG. 9B shows an XRD pattern of a calcined LPS compound.

FIG. 10 shows an image of LPS pellets after calcination.

FIG. 11 shows an image of a coated polypropylene separator.

FIG. 12 shows an SEM image of a cross-sectional view of a solid electrolyte later on top of a polypropylene separator. The scale bar is 10 μm.

FIG. 13 shows a plot of voltage (in Volts (V)) versus time (in hours (h)) showing the voltage profile of a plating/stripping test in a symmetric cell. The (green) curve with the values that are clustered closer to 0.000 V at time greater than 80 h is for protected anode; and the (black) curve with the values that are farther away from 0.000 V at time greater than 80 h is for unprotected anode (black).

FIG. 14 shows a plot of percent of initial capacity versus cycle number, showing capacity retention during cycling for a pellet on a lithium (Li) anode compared to no pellet on an Li anode in a Li battery versus a lithium iron phosphate (LFP) battery. The (orange) curve with the higher percent of initial capacity value at cycle 200 is for ‘pellet on Li anode’; and the (blue) curve with the lower percent of initial capacity value at cycle 200 is for ‘no pellet on Li anode’.

FIG. 15 shows a plot of percent of initial capacity versus cycle number, showing capacity retention during cycling for a coated Li anode compared to an uncoated Li anode in a Li battery versus a nickel cobalt aluminum (NCA) battery. The (orange) curve with the higher percent of initial capacity value at cycle 150 is for ‘coated lithium anode’; and the (blue) curve with the lower percent of initial capacity value at cycle 150 is for ‘uncoated Li anode’.

FIG. 16 shows a plot of percent of initial capacity versus cycle number, showing capacity retention during cycling for a coated Celgard separator facing the Li anode compared to an uncoated Celgard separator in a Li battery versus a nickel manganese cobalt (NMC 811) battery. The (orange) curve with the higher percent of initial capacity value at cycle 100 is for ‘coated Celgard on lithium anode’; and the (blue) curve with the lower percent of initial capacity value at cycle 100 is for ‘uncoated Celgard’.

### DETAILED DESCRIPTION

Embodiments of the subject invention provide novel and advantageous solid-state electrolytes (e.g., lithium palladium sulfide) for use in lithium-ion (Li-ion) batteries, as well as methods of synthesizing the same, methods of preparing the same into a film, and methods of using the same in a Li-ion battery. The solid-state electrolytes of embodiments provide improved stability of the battery over the cycling life (e.g., over 650 cycles), as well as the ability for the battery to resist lithium anode corrosion and/or protection for the battery from shorting by blocking the formation and crossover of dendrites. Solid-state electrolyte pellets can be prepared in a solution, and a film using the synthesized pellet can be formed and used in a Li-ion battery. The batteries comprising the solid-state electrolyte exhibit higher stability and lower capacity fade over the life of many cycles (e.g., 650 cycles).

In an embodiment, a powder of the solid-state electrolyte material can be prepared first. A lithium salt, a platinum-group-metal salt or other conductive-metal salt, and a sulfur component (e.g., thiourea) can be dissolved in a solvent, such as a polar solvent (e.g., acetone, acetonitrile, dimethylsulfoxide, or preferably water). The mixture can be stirred until the constituents are completely dissolved, and it can then be heated (e.g., in a hydrothermal reactor and placed in an oven at a predetermined temperature (e.g., 140° C.) for a predetermined time (e.g., 12 hours). A precipitate can then be collected (e.g., by centrifugation) and washed (e.g., with the same solvent used previously) at least once (e.g., four times). The washing can be done by, for example, resuspension into the solvent using vortexing and/or sonication followed by centrifugation and discarding the supernatants. The recovered solids can then be dried (e.g., at a set temperature (e.g., 60° C.), optionally under vacuum, to completely dry). The dried solids can then be crushed into fine powder (e.g., using ball milling, optionally under an inert atmosphere such as argon atmosphere). The obtained powder can be stored (e.g., in an inert atmosphere, such as under argon) until use in preparing a solid-state electrolyte pellet and/or composite gel-polymer electrolyte films.

The lithium salt can be, for example, lithium nitrate, lithium carbonate, lithium acetate, lithium sulfate, or lithium phosphate, though embodiments are not limited thereto. The platinum-group-metal salt or other conductive-metal salt can be, for example, a palladium salt, a platinum salt, a rhodium salt, an iridium salt, an osmium salt, a ruthenium salt, a silver salt, or a cobalt salt, though embodiments are not limited thereto. The platinum-group-metal salt or other conductive-metal salt can be a nitrate (e.g., palladium nitrate, platinum nitrate, rhodium nitrate, iridium nitrate, osmium nitrate, ruthenium nitrate, silver nitrate, cobalt nitrate), carbonate, acetate, sulfate, or phosphate, though embodiments are not limited thereto.

In some embodiments, the lithium salt can be substituted and a sodium salt or magnesium salt can be used instead (e.g., sodium nitrate or magnesium nitrate). Ternary compounds, such as sodium palladium sulfide and/or magnesium palladium sulfide, can be produced for applications in sodium-ion batteries and/or magnesium-ion batteries.

The prepared powder can be used to prepare a pellet, prepare a composite gel polymer electrolyte, and/or deposit a film of the powder material. In pellet preparation, the powder can be placed in a press die and compressed at a predetermined pressure (e.g., 75 MPa) for a predetermined time (e.g., two minutes) at a predetermined temperature (e.g., ambient temperature). The resulting pellet can be recovered and undergo a heat treatment (e.g., at 350° C. under nitrogen for 2 hours) to give the final pellet. The pellet can optionally be crushed (e.g., by ball milling), re-pelletized, and heat treated a second time.

In composite gel polymer electrolyte preparation, the powder can be mixed in a container (e.g., a mortar and pestle) while a solution is added. The solution can be added dropwise and can comprise, for example, by volume 19.5% trimethylolpropane ethoxylate triacrylate (Mn˜428), 0.5% 2-hydroxy-2-methylpropiophenone, and 80% of tetraethylene glycol dimethyl ether containing 1 mole/liter (mol/L) lithium bis(trifluoromethanesulfonyl)imide. The resulting slurry can be coated (e.g., using a doctor blade method) on a substrate (e.g., a glass substrate) or directly on a separator (e.g., a polypropylene separator such as Celgard 2400). The deposited layer can be cured (e.g., using low power ultraviolet irradiation for 20 minutes) until the film solidifies into a free-standing gel. The flexibility of the film can be controlled by the powder content. Higher powder content yields stiffer films while lower powder content yields more flexible films. The thickness of the film can be controllable, and a thickness of the deposited layer can be in a range of, for example, 2 nanometers (nm) to 200 μm (e.g., 1 μm to 100 μsuch as 20 μm or about 20 μm).

In deposition of a film, the heat treated crushed powder can be pelletized over a substrate (e.g., a copper substrate (e.g., 1 mm thick)) using a binder (e.g., an indium foil) at a predetermined temperature and pressure and for a predetermined time (e.g., at 175° C. and 250 kN for 5 minutes) to obtain a sputter target (e.g., a sputter target of 2 inches or about 2 inches). The target can then be used in a plasma coater under an inert environment (e.g., an argon environment) to deposit a film of the powder material on a substrate. The film can be deposited directly on: (1) the anode as anode protection; (2) the separator as an interlayer; and/or (3) the cathode to prevent or inhibit ion/intermediate species leakage from the cathode in batteries (e.g., polysulfides in Li—S batteries or oxygen, nitrogen, moisture, and/or carbon dioxide in Li-air batteries). The film can be, for example, lithium palladium sulfide (LPS), lithium platinum sulfide, lithium rhodium sulfide, lithium iridium sulfide, lithium osmium sulfide, lithium ruthenium sulfide, lithium silver sulfide, or lithium cobalt sulfide. The ionic conductivity of solid-state electrolytes according to embodiments of the subject invention can be, for example, greater than 0.10 milliSiemens per centimeter (mS/cm).

In many embodiments, a lithium-ion battery can comprise a solid-state electrolyte as described herein. The film described above can be used to prepare a lithium-ion battery, with the film as the electrolyte. The cathode can be, for example, lithium iron phosphate, though embodiments are not limited thereto; and the anode can be, for example, a lithium metal anode, though embodiments are not limited thereto. The cathode can optionally be soaked with liquid electrolyte. The lithium-ion batteries can have excellent stability and performance over more than 450 cycles (e.g., higher than 50% of the theoretical capacity for nearly 500 cycles, and/or running for about 750 cycles before dropping below 50 mAh/g.

Solid-state electrolytes of embodiments of the subject invention (e.g., LPS) are ion conductors with ionic conductivities that exceed the threshold for effective use in lithium-ion batteries. They are not soluble in water and organic solvents, making them ideal for use in battery systems that contain liquid electrolytes because they remain robust and do not leak into the liquid phase. The solid-state electrolytes are also highly stable with temperature stability exceeding 500° C. under nitrogen.

The films of embodiments of the subject invention can be used as solid-state electrolytes in Li-ion batteries and can either substitute for the separator and liquid electrolyte or work in coordination with one or both of these. They can also be used as anode protection, in which the anode can be, e.g., lithium metal, graphite, silicon, or a combination of thereof to prevent or inhibit excessive solid-electrolyte interface formation and dendrite formation. They can also be used as a layer on the separator film as an interlayer to prevent or inhibit dendrite crossover or the crossover of other species in other battery systems (e.g., polysulfides in lithium-sulfur batteries or oxygen, nitrogen, moisture, and/or carbon dioxide in lithium-air batteries). The films can also be used on the cathode side to prevent or inhibit loss of active species from the cathode (e.g., diffusion of dissolved sulfur or polysulfides from the cathode). The solid-state electrolyte films can be purely the material (e.g., LPS), include a binder, be a composite with a polymer electrolyte, or be a composite with a gel polymer electrolyte. The solid-state electrolyte film can be applied to an anode, a separator, and a cathode simultaneously, and they have applications in various lithium batteries including lithium-ion, lithium-sulfur, lithium-air, lithium-silicon, and lithium-bromine batteries, as well as in sodium-ion batteries and magnesium-ion batteries.

The synthesis methods of embodiments of the subject invention are efficient and yield highly pure species that can be further purified by washing to remove Li₂S, LiOH, LiNO₃, PdNO₃, thiourea, and/or other unreacted or by-products. The methods can be used to produce many different types of solid-state electrolytes (e.g., LPS, lithium platinum sulfide, lithium rhodium sulfide, lithium iridium sulfide, lithium osmium sulfide, lithium ruthenium sulfide, lithium silver sulfide, and/or lithium cobalt sulfide). The solid-state electrolyte films can be prepared by pressurized pellets, films coated by doctor blade, plasma deposition, chemical deposition, and/or by in situ deposition in the batteries from the precursors used in the synthesis. The thickness of the solid-state electrolyte film can be in a range of from 2 nm to 200 μm, and the film can be either non-porous or porous.

When ranges are used herein, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kilogram” means from 0.95 kilograms to 1.05 kilograms.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to the invention.

### Example 1—Powder Preparation

Lithium nitrate, palladium nitrate, and thiourea at molar ratios of 2:3:8 were dissolved in a polar solvent (different solvents were used, including acetone, acetonitrile, dimethylsulfoxide, and water). The mixture was well-stirred until completely dissolved then added to a hydrothermal reactor and placed in an oven at 140° C. for 12 hours. After the reaction was completed a black precipitate was collected by centrifugation and washed 4 times with the same polar solvent (used for dissolving the lithium nitrate, palladium nitrate, and thiourea) by resuspension into the solvent using vortexing and sonication followed by centrifugation and discarding the supernatants. The recovered solids were then dried at 60° C. under vacuum to completely dry. The dried solids were then crushed into fine powder using ball milling under argon atmosphere. The obtained lithium palladium sulfide (LPS) powder was stored under argon until its use in preparing a solid-state electrolyte pellet and/or a composite gel-polymer electrolyte film.

### Example 2—Preparation of Electrolyte Pellet

Using the LPS powder prepared in Example 1, 50 milligrams (mg) of the powder was placed in a half-inch pellet press die and then compressed at 75 megaPascals (MPa) for two minutes at ambient temperature. The resulting pellet was recovered and underwent a heat treatment at 350° C. under nitrogen for 2 hours. The pellets were then crushed by ball milling, re-pelletized, and heat treated a second time at 350° C. under nitrogen for 2 hours.

### Example 3—Preparation of Composite Gel Polymer Electrolyte

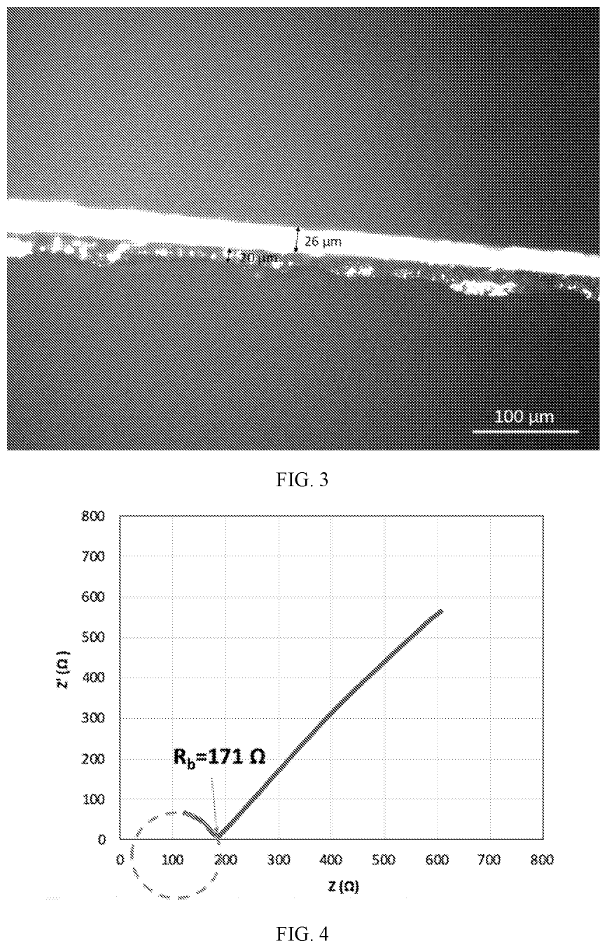

Using the powder from Example 1, 150 mg of the LPS powder was mixed in a mortar and pestle while dropwise 50 mg of a solution was provided, the solution containing by volume 19.5% trimethylolpropane ethoxylate triacrylate (Mn˜428), 0.5% 2-hydroxy-2-methylpropiophenone, and 80% of tetraethylene glycol dimethyl ether containing 1 mol/L lithium bis(trifluoromethanesulfonyl)imide. The resulting slurry was coated using a doctor blade method on a glass substrate or directly on a polypropylene separator (e.g., Celgard 2400). The layer was cured using low power ultraviolet irradiation for 20 minutes until the film solidified into a free-standing gel. The flexibility of the film was determined by the content of the powder. Higher powder content yielded stiffer films while lower powder content yielded more flexible films. The thickness of the film was controllable, and typical layer thickness was 20 μm or about 20 The LPS composite gel polymer electrolyte can be seen in FIGS. 2 and 11, and a scanning electron microscope (SEM) image of the LPS composite gel polymer electrolyte deposited on the surface of the polypropylene separator is shown in FIG. 3.

### Example 4—Plasma Deposition of LPS Films

Using the LPS powder from Example 1, 1 g of LPS was pelletized over a copper substrate (1 millimeter (mm) thick) using an indium foil as a binder (0.1 mm) at 175° C. and 250 kiloNewtons (kN) for 5 minutes to obtain a 2 inch sputter target. The target was then used in a plasma coater under an argon environment to deposit LPS on substrates. The deposited LPS layer was 200 nanometers (nm) thick after 2 minutes of deposition. The sputtered films were used to deposit directly on: (1) the anode as anode protection; (2) the separator as an interlayer; and/or (3) the cathode to prevent or inhibit ion/intermediate species leakage from the cathode in batteries (e.g., polysulfides in Li—S batteries).

### Example 5—Measuring Ionic Conductivity

The electrolyte pellets from Example 2 were placed between two blocking electrodes of stainless steel and were studied using electrochemical impedance spectroscopy between 2 megahertz (MHz) and 0.1 Hertz (Hz). The Nyquist plot is presented in FIG. 4 and was analyzed using the equivalent circuit model that accounts for bulk, grain boundary, and interfacial resistances. The ionic conductivity through the bulk of the films was obtained from the diameter of the semi-circle of the Nyquist plot, when present. The resistance corresponds to the Zᵣₑₐₗ in the frequency range of 10-100 kilohertz (kHz). The ionic conductivity was calculated using the equation:

$$σ = \frac{L}{Z \cdot A}$$

where L is the thickness of the film in centimeters (cm), Z is the bulk resistance in Ohms, A is the area of the film in cm², and a is the film's ionic conductivity is Siemens per centimeter (S/cm).

### Example 6—Using the Solid-State Electrolyte in a Li-Ion Battery

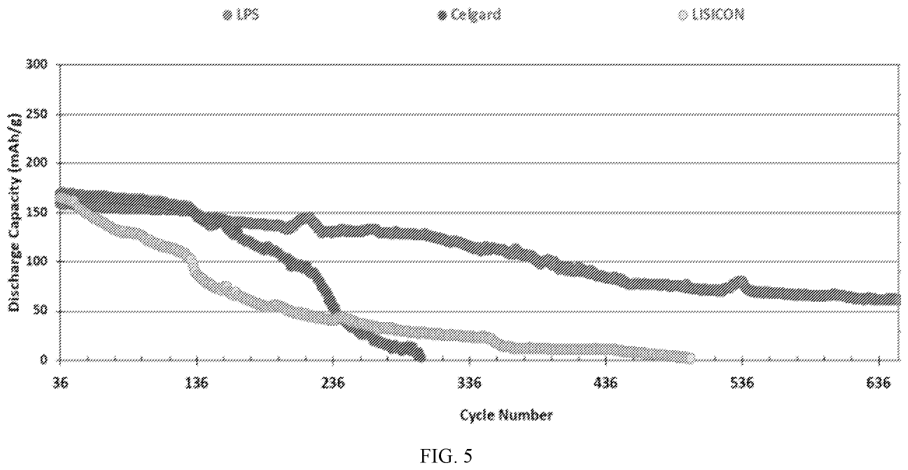

The LPS film from Example 4 was used to prepare lithium-ion batteries using a lithium iron phosphate (LPF) cathode, a lithium metal anode, and LPS (i.e., the LPS film) as the electrolyte. The cathode was still soaked with liquid electrolyte (1:1 EC:DMC with 1M LiPF₆). The batteries were compared to liquid electrolyte soaked in Celgard separator and liquid electrolyte soaked in LISICON commercial solid-state electrolyte. The batteries were tested at initial cycles of C/10, C/5, C/3, C/2, 1C, 2C, and 5C for five cycles each then cycled at 1C indefinitely. FIG. 5 shows the cycling plot for the 1C cycling. The stability of the LPS containing cells was apparent, where liquid electrolyte ones showed an initial good performance and then rapidly declined after cycles 130 to ultimately die around cycle 300. The LISICON cells weren't as good, and their capacity fade was at a faster pace from the beginning. The LPS batteries (120 μm-thick film) remained functional and with higher than 50% of the theoretical capacity for nearly 500 cycles and ran for a total of 750 cycles before dropping below 50 mAh/g. The LPF loading was 4.85 milligrams per square centimeter (mg/cm²).

### Example 7—Aqueous Sulfurization

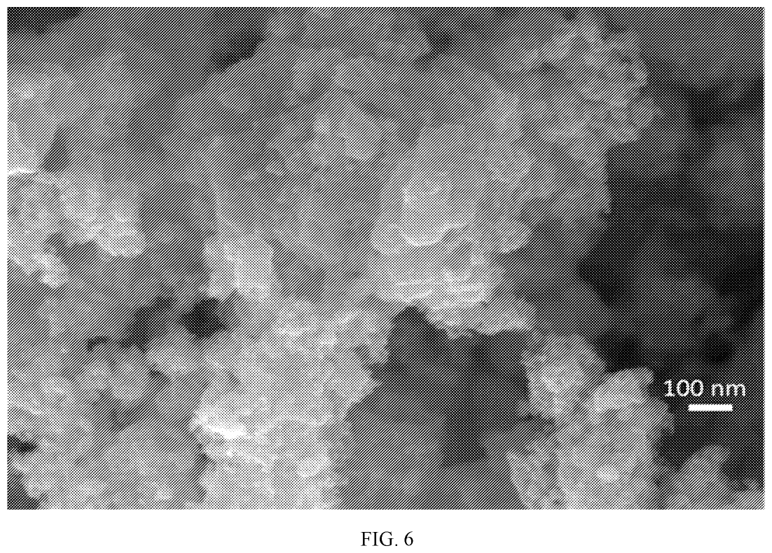

LPS powder was synthesized using the nitrate salts of lithium and palladium (LiNO₃ and Pd(NO₃)₂) at various molar ratios of from 1:1 to 24:1 (Li:Pd) and using the sulfur source precursor thiourea at a molar ratio of 10:1 (S:Pd). In many assemblies, Li:Pd:S atomic ratio of 4:1:10 was used, and the salts and the sulfur source were dissolved in water then placed in a sealed reactor at 140° C. for 24 hours. Upon decomposition of the thiourea to produce sulfides (e.g., especially hydrogen sulfide), the co-precipitation reaction of the lithium sulfide and palladium sulfide yields the formation of the insoluble ternary compound of LPS. The precipitate was recovered by filtration and washed three times using deionized (DI) water with a final (fourth) wash of acetone. The compound was then dried at 50° C. under vacuum for 12 hours, followed by calcination under argon at 400° C. for 2 hours, and then was stored under argon until further use. FIG. 6 is a scanning electron microscope (SEM) image that depicts the resulting dry powder showing nano- and submicron-sized flaky structures. Based on the starting precursors atomic ratios, a final product of 4:1:2 (Li:Pd:S) atomic ratio was obtained.

### Example 8—Mechanical Ball Milling

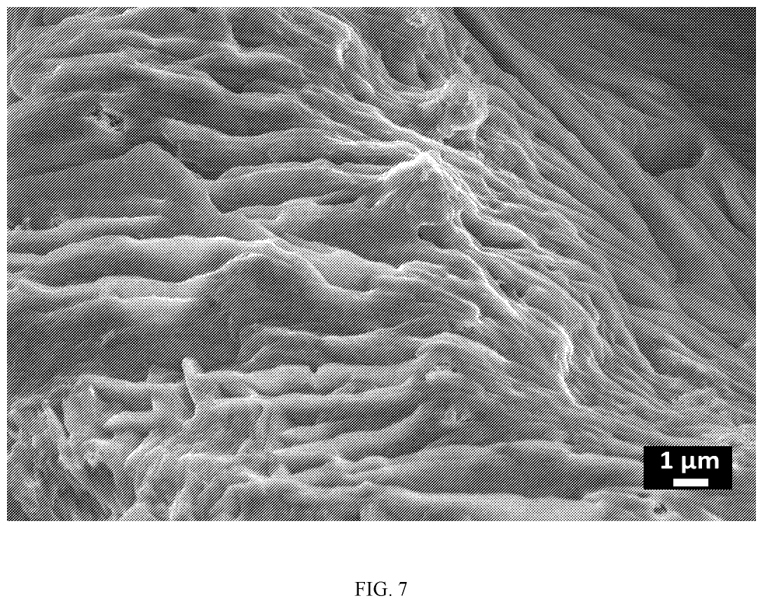

Using a ball mill, lithium sulfide (Li₂S) and palladium sulfide (PdS) were mixed at various ratios from 2:1 to 8:1 (Li₂S:PdS) in 45 ml of zirconia and milled at 600 revolutions per minute (rpm) for 10 hours under argon. The recovered compound was washed three times using DI water with a final (fourth) wash of acetone. The compound was then dried at 50° C. under vacuum for 12 hours, followed by calcination under argon at 400° C. for 2 hours, and then was stored under argon until further use. FIG. 7 is an SEM image of the resulting powder depicting flaky structures with submicron thickness.

### Example 9—Electrochemical Formation

Using the acetate salts of lithium and palladium (C₂H₃LiO₂ and C₄H₆O₄Pd) dissolved in water at a molar ratio of 1:1 to 24:1 (Li:Pd) and using thioacetamide as the sulfur source at 10:1 (S:Pd), the mixed aqueous solution was soaked in a glass fiber disc and placed between two aluminum electrodes. The cell was maintained at 80° C. while a potentiostatic operation at 1 V was carried for 20 minutes. The negative electrode was coated with the precipitated sulfides, which were then recovered, rinsed with water (e.g., DI water), then rinsed with acetone, and prepared for further use by storing them under argon.

### Example 10—Characterization of the Lps Compound

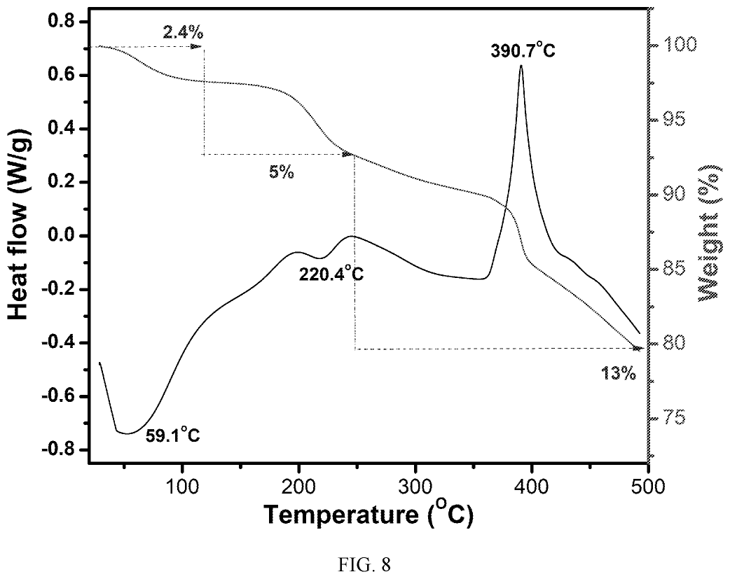

The LPS compounds produced in Examples 7-9 were characterized by differential scanning calorimetry (DSC) and X-ray diffraction (XRD). The DSC in FIG. 8 shows an endothermic broad peak between below 100° C. corresponding to a weight loss of absorbed water, an endothermic peak around 220° C. corresponding to the loss of sulfur, and an exothermic peak around 391° C. corresponding to the crystallization of the compound.

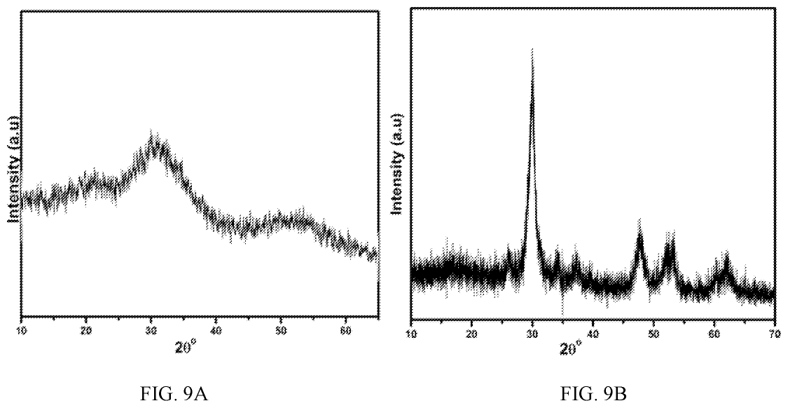

Referring to FIGS. 9A and 9B, the XRD patterns show an amorphous structure for the compound tested after synthesis (FIG. 9A). However, after 2 hours of calcination at 400° C. under argon, the compound shows some crystalline structure and the peaks are in agreement with other palladium sulfide compounds (FIG. 9B).

### Example 11—Film Preparation Via Pelletizing

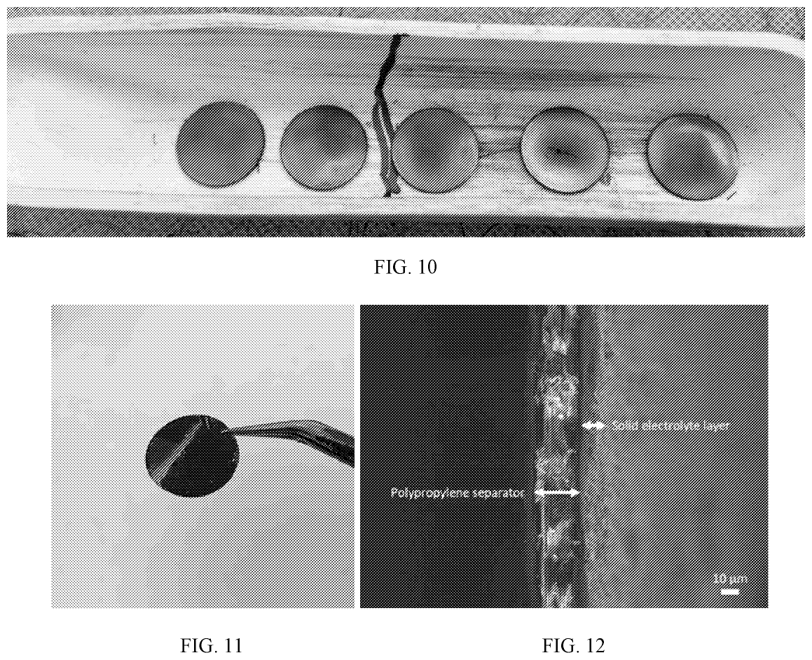

Using the dry and calcined LPS, the powders (from Examples 7-9) were finely crushed and pelletized into a 0.5-inch pellet at 75 tons. The pellet was then dried at 50° C. under vacuum, calcined at 400° C. under argon for 2 hours, and then stored under argon for later use as electrolytes/anode protection layers in Li-ion batteries. FIG. 10 shows an image of the LPS pellets after calcination.

### Example 12—Film Preparation Via Vacuum Filtration on a Separator

The LPS powders from Examples 7-9 were suspended in a 75 milliliter (ml) tetrahydrofuran solution containing 5% polyvinylpyrrolidone binder using probe sonication. The stable suspension was then vacuum-filtered on a 12 square centimeter (cm²) polypropylene film to yield a conformal film of controllable milligram per square centimeter (mg/cm²) loading depending on the mg/ml loading of the LPS in the solution. The film, which can be seen in FIGS. 2, 11, and 12, was then dried under vacuum at 50° C. and stored under argon for later analyses and use.

### Example 13—Film Preparation Via Sputter Coating on Foil

Using the dry and calcined LPS, the powders (from Examples 7-9) were finely crushed and pelletized into a 2-inch pellet at 75 tons. The pellet was then dried at 50° C. under vacuum and then the sputter target was prepared by fixing the pellet to a copper disc using an indium foil as a binder at 160° C. The resulting sputter target was then stored under argon until later use.

In order to sputter LPS on a lithium substrate (e.g., lithium foil), cycles of 30 seconds of coating followed by 30 seconds of rest were employed. Depending on the numbers of the sputter/rest cycles, various thicknesses of the films were achieved. Typically a 10-cycle of sputter yielded approximately 0.1 μm of continuous film. The smoothness and the pristine structure of the anode were essential for uniform layer formation.

### Example 14—Electrochemical Characterization of the Film

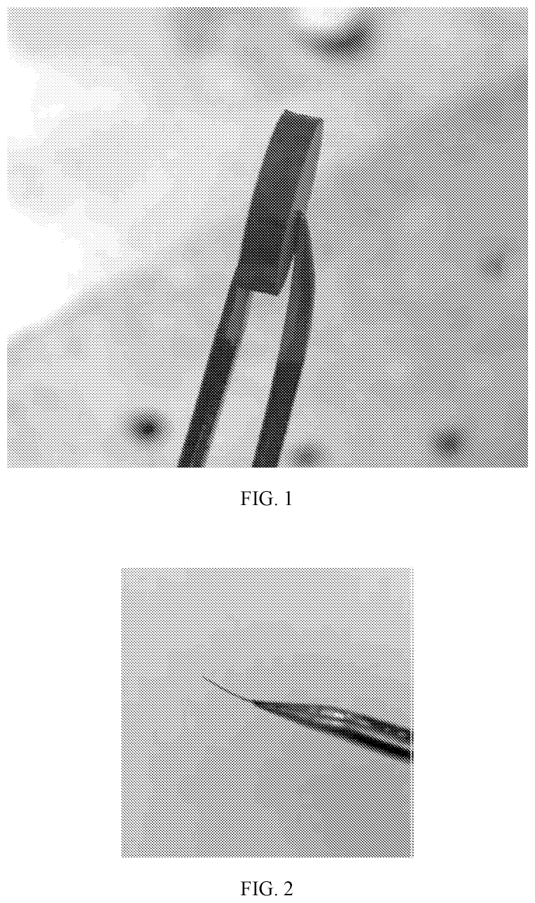

In order to determine the ionic conductivity of the LPS, an LPS pellet was placed between two lithium metal anodes in a Swagelok assembly and electrochemical impedance spectroscopy data were collected between 2 megahertz (MHz) and 1 Hertz (Hz) to obtain the diameter of the high-frequency semi-circle. FIG. 1 shows an image of the pellet, with a thickness of about 1 millimeter (mm). The resistance obtained from this diameter was used using the following equation to calculate the ionic conductivity, σ, in Siemens per centimeter (S.cm¹).

$$σ = \frac{L}{Z \cdot A}$$

where L is the pellet thickness, A is the pellet area, and Z is the real resistance obtained using the diameter of the high-frequency semi-circle (see FIG. 4). An average value of 0.74×10⁻³ S.cm⁻¹ was obtained.

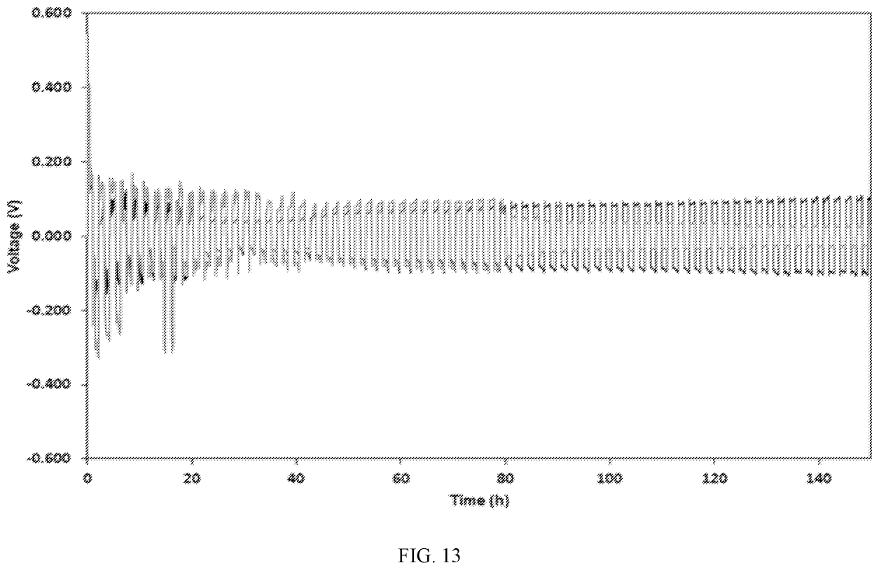

In order to determine the compatibility of the electrolyte with a lithium metal anode, a plating and stripping in a lithium-lithium symmetric test was conducted. The symmetric cells had coated lithium electrodes and were compared with control cells that were unprotected using the LPS layer. A Celgard separator soaked in 50:50 ethylene carbonate:dimethyl carbonate (EC:DMC) containing 1 mole per liter (mol/L) lithium hexafluorophosphate (LiPF₆) was used to separate the two electrodes. The cells were cycled at 3 milliamps per square centimeter (mA/cm²) current density for 1 hour of plating and 1 hour of stripping (see also FIG. 13).

### Example 15—Lps Films as Solid-State Electrolytes in Batteries

The LPS films were used to prepare lithium-ion batteries and determine the stabilizing effect it afforded in various battery chemistries at 1C discharge rate. The batteries were tested in lithium iron phosphate (LFP), nickel cobalt aluminum (NCA), and nickel manganese cobalt (NMC 811) cathode materials versus lithium anodes. For the LFP cells, a 200 μm thick pellet of LPS was used on the anode side and the capacity retention performance versus 1M LiPF₆ in EC:DMC electrolyte was demonstrated.

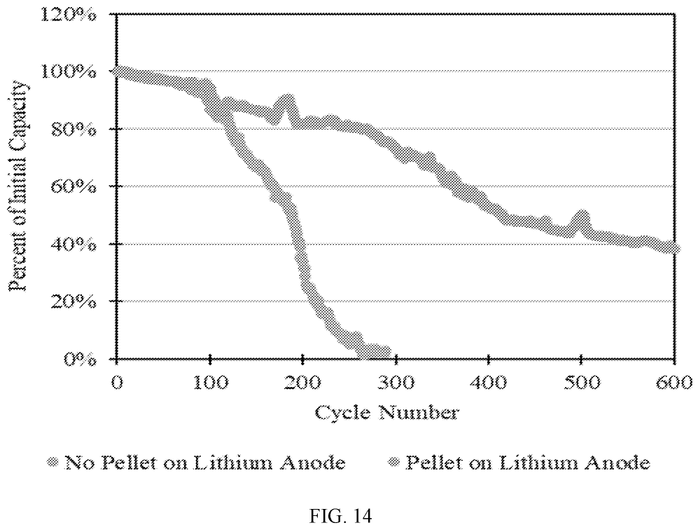

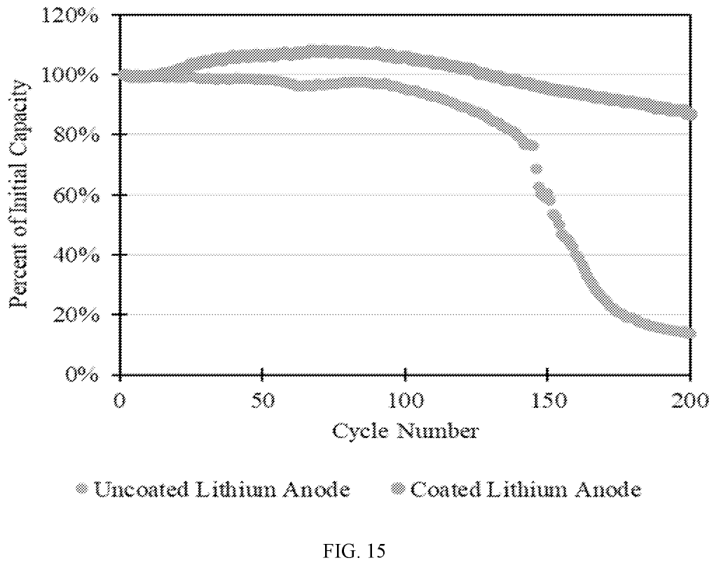

The battery was prepared with the pellet facing the lithium anode side while the cathode side had the polypropylene separator soaked in 1M LiPF₆ in EC:DMC electrolyte. The pellet battery showed improved capacity retention during cycling at 1C. The battery that did not contain the solid electrolyte pellet reached 80% of its initial capacity at cycle 123 and 70% of its initial capacity at cycle 141. When the solid electrolyte pellet was used, the 80% capacity retention cycle was 270, and the 70% capacity retention cycle was at 307 (see FIG. 14). It was also apparent that the battery without the solid-electrolyte pellet rapidly dropped in performance to near zero capacity retention while the pellet-containing cell continued to retain around 40% of its capacity even after 500 cycles. Using lithium sputtered with approximately 500 nanometers (nm) of LPS, the lithium anodes were used in lithium (anode) versus NCA (cathode) batteries at 1C discharge rates. The capacity retention of the batteries was clearly improved with coated anodes versus uncoated anodes. The uncoated anodes showed 139 cycles until 80% capacity retention and 146 cycles until 70% capacity retention. For the coated anodes, capacity retention exceeding 84% was achieved until 200 cycles (see FIG. 15).

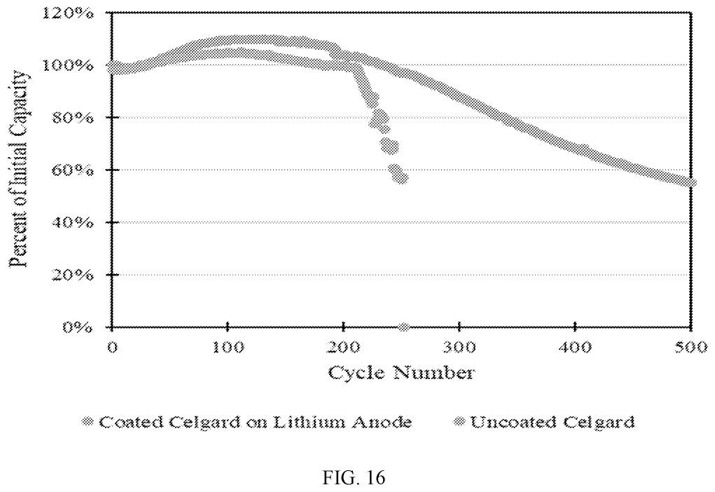

The Celgard polypropylene separators previously coated with LPS were used to prepare batteries using a lithium metal anode and an NMC 811 cathode with the 1M LiPF₆ EC:DMC electrolyte. The batteries were cycled at 1C discharge rate in the 2.5 Volt (V) -4.2 V range. The uncoated Celgard had 232 cycles until 80% capacity retention and 236 cycles until 70% capacity retention, showing a very rapid capacity drop beyond 200 cycles. The coated Celgard had 334 cycles until 80% capacity drop and 388 cycles until 70% capacity retention and maintained a relative slow capacity drop until at least 500 cycles (see FIG. 16).

These results show that the LPS compounds of embodiments of the subject invention are very advantageous for lithium anodes (e.g., as coatings or as pellets on the anode or as coating on a separator facing the anode) in lithium batteries, regardless of the cathode material.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “Background” section) are incorporated by reference in their entirety, including all figures and tables, to the extent they are not inconsistent with the explicit teachings of this specification.

1. A battery, comprising:
an anode;
a cathode; and
a solid-state electrolyte disposed between the anode and the cathode,
at least one of the anode and the cathode comprising lithium, and
the solid-state electrolyte comprising lithium palladium sulfide (LPS), lithium platinum sulfide, lithium rhodium sulfide, lithium iridium sulfide, lithium osmium sulfide, lithium ruthenium sulfide, lithium silver sulfide, or lithium cobalt sulfide.

2. The battery according to claim 1, the anode and the cathode both comprising lithium.

3. The battery according to claim 1, the cathode comprising lithium iron phosphate (LFP), nickel cobalt aluminum (NCA), or nickel manganese cobalt (NMC).

4-5. (canceled)

6. The battery according to claim 1, the solid-state electrolyte having an ionic conductivity of greater than 0.10 milliSiemens per centimeter (mS/cm).

7. The battery according to claim 1, further comprising a separator disposed between the anode and the cathode,
the solid-state electrolyte comprising a film disposed as an interlayer on the separator.

8-15. (canceled)

16. The battery according to claim 1, the solid-state electrolyte being disposed in the form of a film with a thickness of from 20 nanometers (nm) to 100 micrometers (μm).

17-19. (canceled)

20. The battery according to claim 1, the battery having higher than 50% of theoretical capacity after at least 450 1C cycles,
the battery having higher than 80% of theoretical capacity after at least 200 1C cycles, and
the battery having higher than 80% of theoretical capacity after at least 300 1C cycles.

21-22. (canceled)

23. A method of fabricating a solid-state electrolyte, the method comprising:
preparing a powder; and
preparing a film of the solid-state electrolyte from the powder,
the solid-state electrolyte comprising lithium palladium sulfide (LPS), lithium platinum sulfide, lithium rhodium sulfide, lithium iridium sulfide, lithium osmium sulfide, lithium ruthenium sulfide, lithium silver sulfide, or lithium cobalt sulfide, and
the preparing of the powder comprising either:
a) dissolving a first salt, a lithium salt, and a sulfur source in a first solvent to form a first solution;
heating the first solution at a first temperature for a first amount of time to precipitate the sulfide compound comprising lithium and a first component from the first salt; and
drying the sulfide compound at a second temperature for a second amount of time to give the powder,
the first salt being a palladium salt, a platinum salt, a rhodium salt, an iridium salt, an osmium salt, a ruthenium salt, a silver salt, or a cobalt salt, and
the first component being palladium, platinum, rhodium, iridium, osmium, ruthenium, silver, or cobalt; or
b) dissolving a second salt, a lithium salt, and a sulfur source in a second solvent to form a second solution;
soaking the second solution in a disc and placing the soaked disc between a positive electrode and a negative electrode to form a first cell;
heating the first cell at a third temperature for a third amount of time while performing a potentiostatic operation on the first cell to precipitate on the negative electrode the sulfide compound comprising lithium and a second component from the second salt; and
recovering the sulfide compound from the negative electrode to give the powder,
the second salt being a palladium salt, a platinum salt, a rhodium salt, an iridium salt, an osmium salt, a ruthenium salt, a silver salt, or a cobalt salt, and
the second component being palladium, platinum, rhodium, iridium, osmium, ruthenium, silver, or cobalt; or
c) mixing, using a ball mill, lithium sulfide (Li₂S) and a second sulfide comprising a transition metal to form a ball mill mixed compound;
milling the ball mill mixed compound at a first speed for a fourth amount of time to form a sulfide compound comprising lithium and the transition metal; and
drying the sulfide compound at a fourth temperature for a fifth amount of time to give the powder,
the transition metal being palladium, platinum, rhodium, iridium, osmium, ruthenium, silver, or cobalt.

24. The method according to claim 23, the preparing of the powder comprising step a), and
step a) further comprising, before drying the sulfide compound, recovering the sulfide compound by a filtration process on the first solution and then washing the sulfide compound.

25. The method according to claim 24, the first salt being a palladium salt, the first component being palladium, and the solid-state electrolyte comprising LPS.

26-28. (canceled)

29. The method according to claim 24, step a) further comprising, after drying the sulfide compound, performing calcination on the sulfide compound under an inert atmosphere at a fifth temperature for a sixth amount of time.

30-37. (canceled)

38. The method according to claim 23, the preparing of the powder comprising step b), and
step b) further comprising, after recovering the sulfide compound, washing the sulfide compound to give the powder.

39. The method according to claim 38, the second salt being a palladium salt, the second component being palladium, and the solid-state electrolyte comprising LPS.

40-50. (canceled)

51. The method according to claim 23, the preparing of the powder comprising step c), and
step c) further comprising, after drying the sulfide compound, performing calculation on the sulfide compound under an inert atmosphere at a sixth temperature for a seventh amount of time.

52. The method according to claim 51, the transition metal being palladium, and the solid-state electrolyte comprising LPS.

53-57. (canceled)

58. The method according claim 51, step c) further comprising, before drying the sulfide compound, recovering the sulfide compound and then washing the sulfide compound.

59-70. (canceled)

71. The method according to claim 23, the preparing of the film of the solid-state electrolyte comprising:
crushing and pelletizing the powder into a pellet;
drying the pellet at a seventh temperature for an eighth amount of time; and
calcining the dried pellet at an eighth temperature for a ninth amount of time to give the film.

72-79. (canceled)

80. The method according to claim 23, the preparing of the film of the solid-state electrolyte comprising:
suspending the powder in a third solution using probe sonication to provide a suspension;
vacuum-filtering the suspension onto a substrate to give the film; and
drying the film at a ninth temperature for a tenth amount of time to give the film.

81-91. (canceled)

92. The method according to claim 23, the preparing of the film of the solid-state electrolyte comprising:
crushing and pelletizing the powder into a pellet;
drying the pellet at a tenth temperature for an eleventh amount of time;
preparing a sputter target using the pellet; and
sputtering the sputter target onto a sputter substrate to provide the film.

93-105. (canceled)

106. A battery, comprising:
an anode;
a cathode;
a solid-state electrolyte disposed between the anode and the cathode; and
a separator disposed between the anode and the cathode,
the anode and the cathode both comprising lithium,
the solid-state electrolyte comprising lithium palladium sulfide (LPS),
the solid-state electrolyte having an ionic conductivity of greater than 0.10 milliSiemens per centimeter (mS/cm),
the solid-state electrolyte comprising a film disposed as an interlayer on the separator,
the battery being a lithium-ion (Li-ion) battery, a lithium-air (Li-air) battery, or a lithium-sulfur (Li-sulfur) battery.
the solid-state electrolyte being disposed in the form of a film with a thickness of at least 20 nanometers (nm),
the battery having higher than 50% of theoretical capacity after at least 450 1C cycles,
the battery having higher than 80% of theoretical capacity after at least 200 1C cycles, and
the battery having higher than 80% of theoretical capacity after at least 300 1C cycles.
